(19) United States
(12) Patent Application Publication
(10) Pub. No.: US 2005/0156436 A1
(43) Pub. Date: Jul. 21, 2005

(54) Trunk lid latch assembly for vehicle

(76) Inventors: Young Un Ju, Hwansung-si (KR); Nam Hyeok Lim, Gunpo-si (KR)

Correspondence Address: MORGAN, LEWIS & BOCKIUS LLP (SF), 2 PALO ALTO SQUARE, PALO ALTO, CA, 94306, US

(21) Appl. No.: 11/028,279

(22) Filed: Dec. 30, 2004

Related U.S. Application Data
(63) Continuation-in-part of application No. 10/885,179, filed on Jul. 6, 2004.

(30) Foreign Application Priority Data
Oct. 14, 2003 (KR) 10-2003-0071511
Mar. 31, 2004 (KR) 10-2004-0022157

(51) Int. Cl. E05C 3/06

(52) U.S. Cl. 292/216

(57) ABSTRACT

The present invention relates to a trunk lid latch assembly for a vehicle that includes a valet parking switch. A trunk lid switch in the vehicle's interior operates a gear that releases a latch to unlock the trunk lid. The valet parking switch is positioned such that when it is in the off position, it engages the gear with the latch, allowing the latch to be released. When the valet parking switch is in the on position, it is disengaged with the gear so that, even if a trunk lid switch is operated, the latch does not release to unlock the trunk.

### CROSS-REFERENCE TO RELATED APPLICATIONS

This application is a continuation-in-part of U.S. application Ser. No. 10/885,179, filed Jul. 6, 2004, which claims priority to Korean Application No. 10-2003-0071511, filed on Oct. 14, 2003, and also claims priority to Korean Application No. 10-2004-0022157, filed on Mar. 31, 2004, the disclosures of which are incorporated herein by reference in their entirety.

### FIELD OF THE INVENTION

The present invention relates to a trunk lid latch assembly including a switch for valet parking, and in particular to a trunk lid latch assembly for a vehicle that turns a valet parking switch on and off via a mechanical mechanism.

### BACKGROUND OF THE INVENTION

Valet parking is a professional parking service provided to customers as a courtesy establishments such as hotels and luxury restaurants, whereby staff at the establishment parks customers' cars during the customers' stays at the establishment. To prevent robbery of valuables left in the trunk during the valet service, a valet parking switch is provided in a vehicle. When a car is parked by a valet, a valet parking switch is turned on, thereby preventing the trunk lid from opening.

Generally, a trunk lid latch assembly equipped with a valet parking switch is locked or unlocked by a motor operated by a trunk lid switch, or by a release rod operated by a vehicle key. During valet parking, when a motor intermittent switch is on, power is disconnected from the motor so that the latch assembly cannot be unlocked even by operating the trunk lid switch. Therefore, the trunk lid cannot be opened by using the trunk lid switch alone and can only be opened by using the vehicle key. Of course, the vehicle key is kept by the valet staff providing the valet parking, and is a sub-key that is not capable of opening the trunk lid.

In a vehicle equipped with a trunk lid latch assembly with a valet parking switch, a motor intermittent switch for valet parking is usually installed in the interior of the vehicle (e.g., the glove box). In this case, wiring is needed control the motor intermittent switch. The wiring, however, may experience a short circuit or other operational problem, including those due to the defects of the valet parking switch. The workability then drastically deteriorates because of the wiring. Additionally, there may be various disadvantages in weight and fabrication costs.

### SUMMARY OF THE INVENTION

The present invention provides a trunk lid latch assembly for a vehicle that is capable of overcoming the problems encountered in the conventional art. The present invention provides a latch assembly with a novel locking/unlocking system that includes a valet parking switch operated by a mechanical mechanism. This removes the requirement of the traditional motor intermittent switch and the accompanying wiring, which consequently results in a trunk lid latch assembly for a vehicle that does not experience defects or operational problems due to wiring short circuits or abnormal operations of a switch.

### BRIEF DESCRIPTION OF THE DRAWINGS

The aforementioned aspects and other features of the present invention will be explained in the following description, taken in conjunction with the accompanying drawings, wherein:

FIG. 1 is a front view illustrating a locked state of a trunk lid latch assembly according to the present invention when a valet parking switch is off;

FIG. 2 is a rear view of FIG. 1;

FIG. 3 is a front view illustrating an unlocked state of a trunk lid latch assembly according to the present invention when a valet parking switch is off;

FIG. 4 is a rear view of FIG. 3;

FIG. 5 is a front view illustrating a locked state of a trunk lid latch assembly according to the present invention when a valet parking switch is on;

FIG. 6 is a rear view of FIG. 5;

FIG. 7 is a front view illustrating an unlocked state of a trunk lid latch assembly according to the present invention when a valet parking switch is on;

FIG. 8 is a rear view of FIG. 7;

FIG. 9 is a perspective view illustrating an assembled state of a valet parking switch in a trunk lid latch assembly according to the present invention; and

FIG. 10 is a perspective view illustrating a disassembled state of a valet parking switch in a trunk lid latch assembly according to the present invention.

### DETAILED DESCRIPTION OF PREFERRED EMBODIMENTS

The preferred embodiments of the present invention will be described with reference to the accompanying drawings.

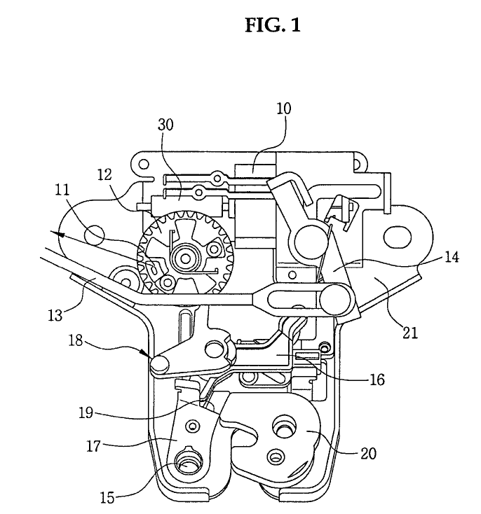

As shown in FIGS. 1 through 8, a motor 10 having a gear shaft 30 is installed in an upper side of a plate 21 that operates as a base. A gear 12 engaged with gear shaft 30 is installed in a lower side of the same. An open lever 14 is pulled by a release rod 13 and is rotated with respect to a central shaft. When operating a trunk lid switch (not shown) provided in the interior of a vehicle, motor 10 rotates gear 12. In addition, open lever 14 can be rotated by release rod 13 by using the vehicle key.

A pole guide 16 is extended within the operation range of open lever 14 wherein pole guide 16 is rotatable with respect to a hinge shaft 15 in a lower side of plate 21. A pole 17 having a shoulder portion 19 for catching a latch 20 is provided in a front surface of a lower side of pole guide 16. A valet parking switch 18 extended within an operation range of the gear is engaged to a front surface of the upper side of pole guide 16. Latch 20 is rotatably installed on plate 21 near pole 17. Latch 21 locks or unlocks a striker (not shown) when the striker moves into a notch in the lower side of plate 21. Thusly, pole guide 16, valet parking switch 18, and pole 17 are rotated by the rotation of open lever 14. Alternatively, pole guide 16 contacts a form part 11 based on the rotation of gear 12, and pole guide 16, valet parking switch 18, and pole 17 may be rotated by form part 11 on gear 12.

Pole guide 16, valet parking switch 18, pole 17, and latch 20 are elastically supported by a spring (not shown), respectively, in one direction, so that pole guide 16 and latch 20 may return to their original positions when an operational force is removed.

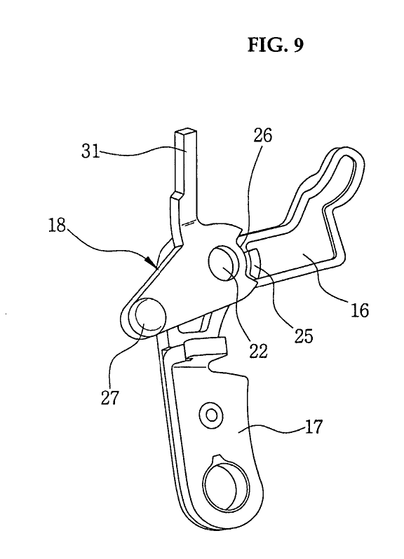

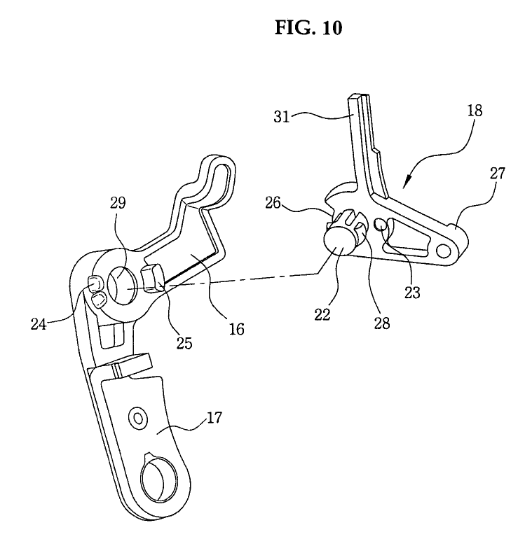

FIGS. 9 and 10 show rotatable engaging structures of valet parking switch 18. A rotation center shaft 22 is formed on a rear surface of valet parking switch 18, such that valet parking switch 18 is rotated with respect to shaft 22, and is capable of tilting at a certain angle before subsequently returning to its original position.

Here, valet parking switch 18 may be connected to pole guide 16 by inserting rotation center shaft 22 into a hole 29 formed in pole guide 16. The structure that engages rotation center shaft 22 to hole 29 may be implemented in various ways. A one touch clip type implementation may be adapted using a protrusion 28 formed in a surrounding surface of rotation center shaft 22 such that protrusion 28 secures rotation center shaft 22 in hole 29 when rotation center shaft 22 snaps into hole 29.

Valet parking switch 18 is capable of tilting at a certain angle before subsequently returning to its original position. For example, a ball part 23 is formed near rotation center shaft 22 on the back surface of valet parking switch 18. At least two engaging grooves 24 are formed in a surrounding portion of hole 29 on the front surface of pole guide 16, so that ball part 23 may be mounted in one of the at least two engaging grooves 24. One mounting position may be set as a tilting position and the other a returning position. A guide groove 26 having a certain section is formed in a lateral surface of valet parking switch 18. A stopper 25 that fits within guide groove 26 is formed on a front surface of pole guide 16 so that the rotation of valet parking switch 18 is limited to two tilting and returning positions.

A lever part 27 extending longitudinally is provided in valet parking switch 18, thereby enabling valet parking switch 18 to be manually operated. An extension part 31 is provided in an upper portion of valet parking switch 18, and contacts form part 11 of gear 12.

The operation of the latch assembly according to the present invention will now be described.

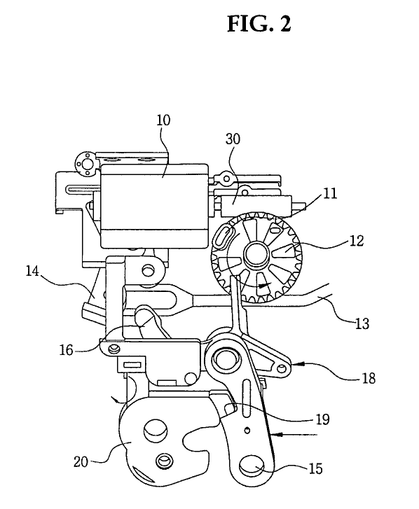

FIGS. 1 and 2 show the locked state (trunk lid is locked) when valet parking switch 18 is off. Valet parking switch 18 is positioned at the returning position in which it is tilted in the left direction such that extension part 31 is positioned along the arc of operation of form part 11 of gear 12.

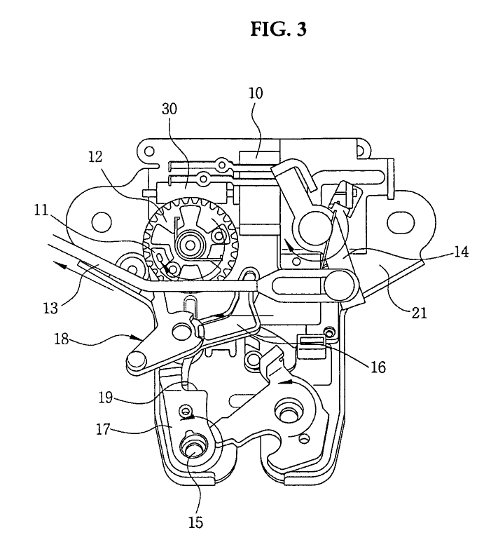

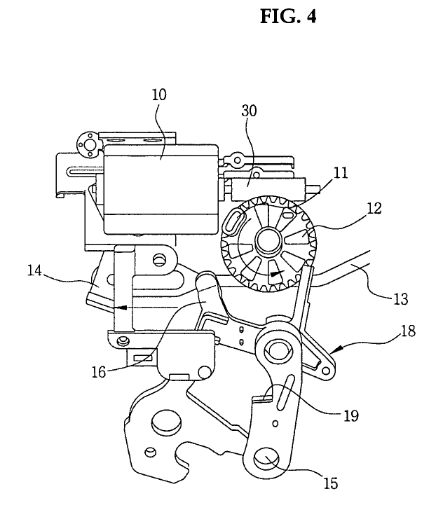

FIGS. 3 and 4 show the unlocking of the trunk lid when either the vehicle key or trunk lid switch is utilized to open the trunk. When the vehicle key is operated to open the trunk lid, release rod 13 rotatably pulls open lever 14, which in turn pushes pole guide 16 so that pole guide 16 is tilted in the left direction. Or, when the trunk lid switch is used to open the trunk, motor 10 operates on gear shaft 30, which engages gear 12 such that form part 11 on gear 12 pushes extension part 31 of valet parking switch 18 so that valet parking switch 18 is tilted in the left direction. Since valet parking switch 18 is engaged with pole guide 16 via rotation center shaft 22, when valet parking switch 18 tilts leftward, pole guide 16 also tilts leftward. The leftward tilt of pole guide 16 (in either cases wherein the vehicle key or the trunk lid switch is utilized) releases latch 20 and disengages latch 20 from the striker, thereby opening the trunk lid.

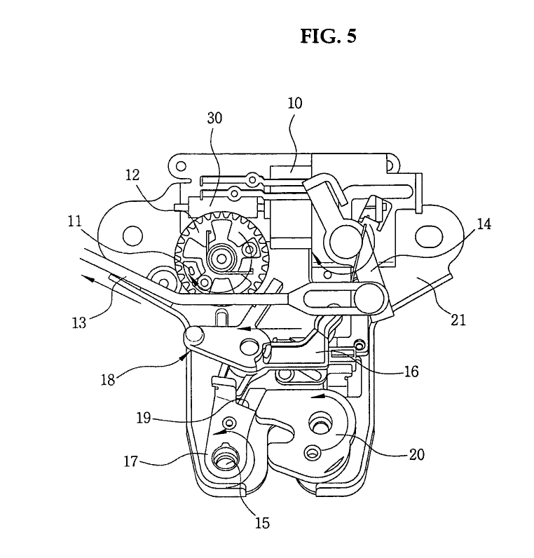

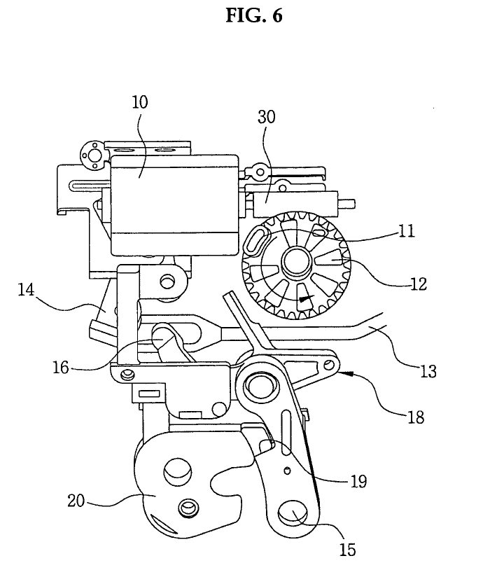

FIGS. 5 and 6 show a locked state when valet parking switch 18 is on. In this state, valet parking switch 18 is tilted in the right direction, positioning extension part 31 out of the arc of operation of form part 11 of gear 12. Now, even when motor 10 is operated by operating the trunk lid switch provided in the interior of the vehicle, no interaction occurs between gear 12 and valet parking switch 18, making it impossible to open the trunk lid with the trunk lid switch.

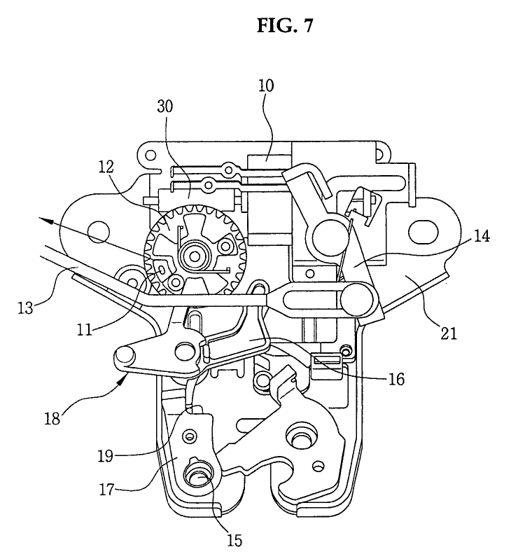

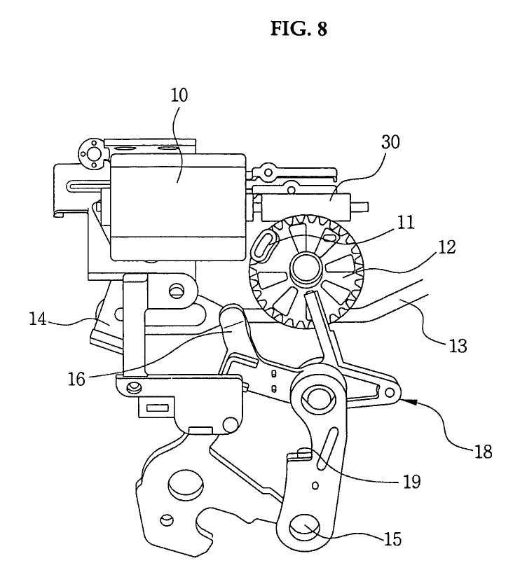

FIGS. 7 and 8 show an unlocked state when valet parking switch 18 is on. When the vehicle key (not the sub-key) is inserted and operated, release rod 13 operates on open lever 14 to push pole guide 16, which in turn pushes pole 17. Pole 17 then releases latch 20, thus releasing the striker that latch 20 was catching.

As described above, the present invention provides a new locking and unlocking type latch assembly including a manually operated valet parking switch that does not utilize any conventional electrical parts. The absence of electrical parts prevents the defects and operational errors traditionally caused by wiring short circuits and switch errors. Additionally, the present invention overcomes workability problems related with wiring work, etc. Further, the total weight and fabrication costs are reduced compared to the conventional art in which many electrical parts are employed.

The foregoing description, for purposes of explanation, used specific examples to provide a thorough understanding of the invention. However, it will be apparent to one skilled in the art that the invention is not limited to these examples. The embodiments were chosen and described in order to best explain the principles of the invention and its practical applications, to thereby enable others skilled in the art to best utilize the invention and various embodiments with various modifications as are suited to the particular use contemplated. Thus, the foregoing disclosure is not intended to be exhaustive or to limit the invention to the precise forms disclosed. Many modifications and variations are possible in view of the above teachings.

It is intended that the scope of the invention be defined by the following claims and their equivalents.

1. A trunk lid latch assembly for a vehicle comprising:
a motor;
a rotation center shaft;
a pole guide;
a valet parking switch, wherein said valet parking switch is rotatably engaged with the pole guide by the rotation center shaft; and
a latch, wherein said latch is positioned in a locked or unlocked position by operation of the motor when the valet parking switch is rotated within a predetermined angle.

2. The assembly of claim 1, wherein said valet parking switch is provided with a protrusion formed on the back surface thereof and at least two mounting parts formed on a front surface of said pole guide, whereby the valet parking switch is toggled on and off state by the engagement and disengagement of the mounting parts with the protrusion.

3. The assembly of claim 2, wherein
said valet parking switch further comprises a guide groove formed on one surface thereof; and
said pole guide further comprises a stopper formed on one surface thereof, the stopper positioned within the guide groove such that the movement of the valet parking switch is restricted by the stopper to two positions of on and off.

4. The assembly of either claim 2, wherein said valet parking switch further comprises a lever part longitudinally extended for manual operation of said valet parking switch.

5. The assembly of either claim 2, wherein said valet parking switch is engaged to a hole of said pole guide in a clip shape by using a protrusion formed in a surrounding portion of said rotation center shaft.
